(19) United States
(12) Patent Application Publication
(10) Pub. No.: US 2005/0068092 A1
(43) Pub. Date: Mar. 31, 2005

(54) Voltage regulator

(76) Inventor: Kazuaki Sano, Chiba-shi (JP)

Correspondence Address: ADAMS & WILKS, 31st Floor, 50 Broadway, New York, NY, 10004, US

(21) Appl. No.: 10/942,453

(22) Filed: Sep. 16, 2004

(30) Foreign Application Priority Data
Sep. 30, 2003 (JP) 2003-341423

(51) Int. Cl. G05F 1/10

(52) U.S. Cl. 327/541

(57) ABSTRACT

The present invention provides a voltage regulator capable of causing a large output current to flow during a heavy load operation, and of making a leakage current from output transistors small during a light load operation. The voltage regulator includes a plurality of output transistors and a circuit for changing connection of the output transistors to allow a W/L value of the output transistor to be changed. Moreover, the voltage regulator further includes an output current detection circuit for detecting an output current, and a circuit for changing connection of the output transistors based on the output current to allow a W/L value of the output transistors to be changed based on the output current.

### BACKGROUND OF THE INVENTION

1. Field of the Invention

The present invention relates in general to a voltage regulator, and more particularly to a voltage regulator capable of decreasing a leakage current from output transistors when a load is light.

2. Description of the Related Art

As shown in FIG. 3, a conventional voltage regulator includes a voltage regulator control circuit having a reference voltage circuit 2, bleeder resistors 6 and 7 for voltage-dividing an output voltage Vout appearing at an output terminal 5 of the voltage regulator, and an error amplifier 3 for amplifying a voltage difference between a reference voltage Vref from the reference voltage circuit 2 and a voltage Va appearing at a node between the bleeder resistors 6 and 7, and an output transistor 4. The voltage regulator operates at a power supply voltage VDD supplied from a voltage source 1.

When an output voltage of the error amplifier 3 is assigned Verr, if the voltage Va is larger than the reference voltage Vref, the output voltage Verr becomes higher, while if the voltage Va is smaller than the reference voltage Vref, the output voltage Verr becomes lower. When the output voltage Verr of the error amplifier 3 becomes higher, the output transistor 4 becomes larger with its ON resistance to serve to decrease the output voltage Vout. On the other hand, when the output voltage Verr of the error amplifier 3 becomes lower, the output transistor 4 becomes smaller with its ON resistance to serve to increase the output voltage Vout. The voltage regulator control circuit holds the output voltage Vout constant by those mechanisms.

Since resistance values of the bleeder resistors 6 and 7 are generally set to very large values, the voltage regulator controls the output transistor 4 so that the ON resistance of the output transistor 4 becomes very larger when a load is light (e.g., refer to JP 07-74976 B (FIG. 2)).

However, if the output transistor 4 is so controlled that its ON resistance becomes very larger when the load is light, there is encountered a problem in that an influence of a leakage current from the output transistor 4 becomes larger and hence the output voltage Vout cannot be held constant. In general, when a channel width and a channel length of a transistor are assigned W and L, respectively, a W/L value is reduced to allow a leakage current from the transistor to be reduced. In this case, however, an amount of current which can be caused to flow when a load is heavy becomes lesser accordingly.

### SUMMARY OF THE INVENTION

In light of the foregoing, the present invention has been made in order to solve the above-mentioned problems associated with the prior art, and it is therefore an object of the present invention to provide a voltage regulator capable of causing a large leakage current to flow when a load is heavy, and of making a leakage current from output transistors small when a load is light.

In order to attain the above-mentioned object, a voltage regulator according to the present invention includes a plurality of output transistors and a circuit for changing connection of the output transistors, in which a W/L value of the output transistors can be changed.

Moreover, a voltage regulator according to the present invention includes an output current detection circuit for detecting an output current and a circuit for changing connection of the output transistors based on the output current, in which a W/L value of the output transistors can be changed based on the output current.

According to the voltage regulator of the present invention, the control is carried out such that the W/L value of the output transistors become smaller when a load is light without reducing an amount of current which can be caused to flow when a load is heavy, whereby it is possible to reduce a leakage current from the output transistors when the load is light.

### BRIEF DESCRIPTION OF THE DRAWINGS

In the accompanying drawings:

FIG. 1 is a circuit diagram of a voltage regulator according to a first embodiment of the present invention;

FIG. 2 is a circuit diagram of a voltage regulator according to a second embodiment of the present invention; and

FIG. 3 is a circuit diagram of a conventional voltage regulator.

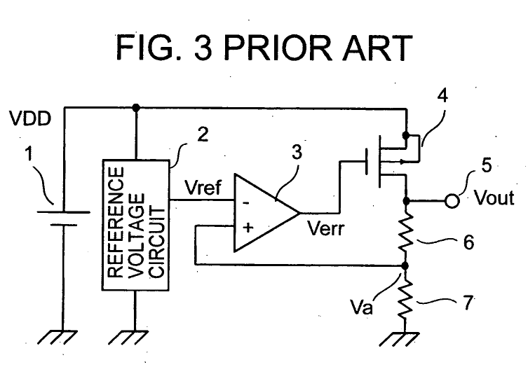

### DESCRIPTION OF THE PREFERRED EMBODIMENTS

First Embodiment

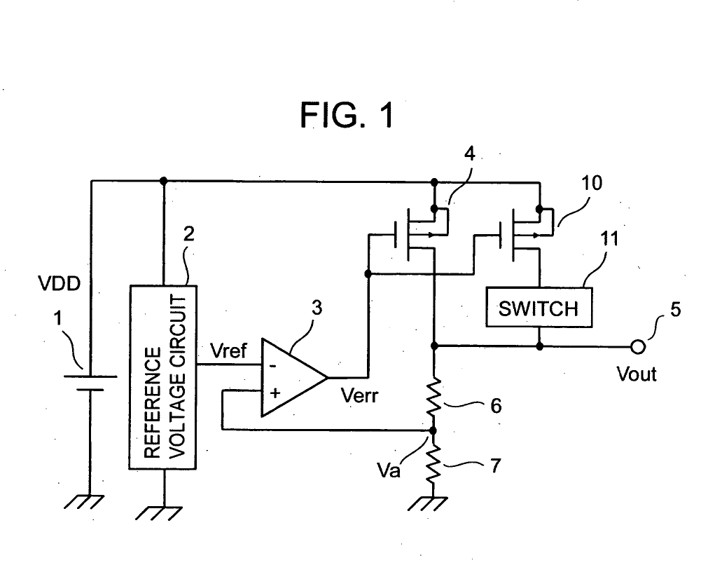

FIG. 1 is a circuit diagram of a voltage regulator according to a first embodiment of the present invention. The voltage regulator according to the first embodiment of the present invention includes a voltage regulator control circuit having a reference voltage circuit 2, bleeder resistors 6 and 7 for voltage-dividing an output voltage Vout of the voltage regulator, and an error amplifier 3 for amplifying a voltage difference between a reference voltage Vref from the reference voltage circuit 2 and a voltage Va appearing at a node between the bleeder resistors 6 and 7, output transistors 4 and 10 connected in parallel, and a switch 11 for changing a W/L value (W is a channel width and L is a channel length) of the output transistors.

The switch 11 operates so as to be turned ON during a normal load operation and so as to be turned OFF during a light load operation.

When the switch 11 is turned ON, the output transistors 4 and 10 are both in output operation, and hence a W/L value of the output transistors becomes a sum of W/L values of both the output transistors 4 and 10. Consequently, during the normal load operation in which an output current is large, the W/L value of the output transistors becomes larger than that of the output transistors during the light load operation, and hence a large current can be caused to flow with the output transistors 4 and 10.

On the other hand, when the switch 11 is turned OFF, only the output transistor 4 is in output operation and hence the W/L value of the output transistors becomes equal to the W/L value of the output transistor 4. Thus, during the light load operation in which the output current is small, the W/L value of the output transistors becomes smaller than that of the output transistors during the normal load operation, and hence a leakage current from the output transistors becomes smaller.

Consequently, during the heavy load operation, the large output current can be caused to flow, while during the light load operation, the leakage current from the output transistors can be reduced.

Second Embodiment

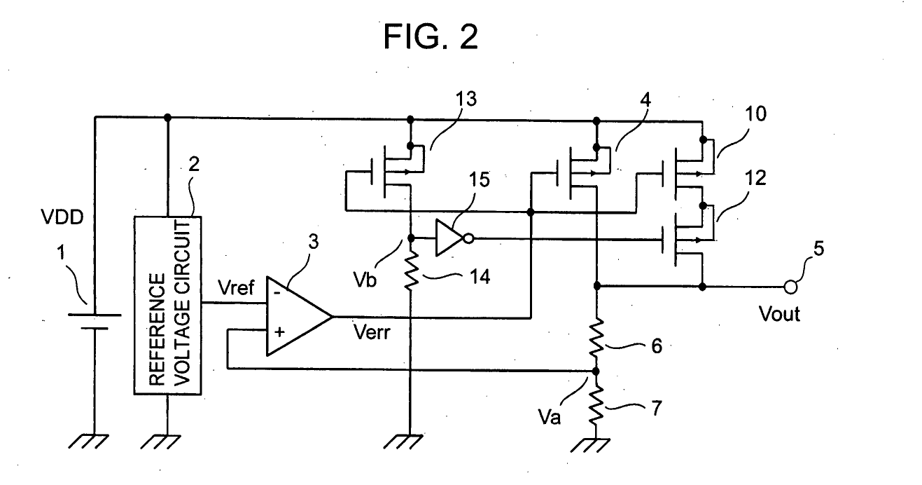

FIG. 2 is a circuit diagram of a voltage regulator according to a second embodiment of the present invention. The voltage regulator according to the second embodiment of the present invention includes a voltage regulator control circuit having a reference voltage circuit 2, bleeder resistors 6 and 7 for voltage-dividing an output voltage Vout of the voltage regulator, and an error amplifier 3 for amplifying a voltage difference between a reference voltage Vref from the reference voltage circuit 2 and a voltage Va appearing at a node between the bleeder resistors 6 and 7, output transistors 4 and 10 connected in parallel, and a switching transistor 12 for changing a W/L value of the output transistors.

A W/L value of the output transistors is changed by the switching transistor 12. The switching transistor 12 is controlled by an output current detection circuit including a transistor 13 connected in parallel with the output transistors 4 and 10, an output current sense resistor 14, and an inverter 15.

During a normal load operation, a current is caused to flow between a drain and a source of the transistor 13 in correspondence to an output current. A drain-to-source current of the transistor 13 is caused to flow through the output current sense resistor 14 to raise an input voltage Vb to the inverter 15. As a result, a gate voltage of the switching transistor 12 decreases to turn ON the switching transistor 12. Turn-ON of the switching transistor 12 results in that the W/L value of the output transistors becomes a sum of the W/L values of the output transistors 4 and 10. Consequently, during the normal load operation in which the output current is large, the W/L value of the output transistors becomes larger than that of the output transistors during the light load operation, and hence a large current can be caused to flow with the output transistors 4 and 10.

During the light load operation, the control is carried out so that the output transistor 4 is turned OFF. Thus, the current caused to flow between the drain and the source of the transistor 13 becomes smaller to reduce the input voltage Vb to the inverter 15. As a result, a gate voltage of the switching transistor 12 increases to turn OFF the switching transistor 12. Turn-OFF of the switching transistor 12 results in that the W/L value of the output transistors becomes equal to the W/L value of the output transistor 4. Thus, during the light load operation in which the output current is small, the W/L value of the output transistors becomes smaller than that of the output transistors during the normal load operation, and hence a leakage current from the output transistors becomes smaller.

Consequently, during the heavy load operation, the large output current can be caused to flow, while during the light load operation, the leakage current from the output transistors can be reduced.

In addition, a resistance value of the output current sense resistor 14, and an inversed voltage of the inverter 15 are changed, thereby making it possible to change a value of an output current with which the switching transistor 12 is turned OFF.

1. A voltage regulator comprising at least a control circuit and a plurality of output transistors that is controlled by the control circuit,
wherein a W/L value of the output transistors is controlled based on a value of an output current.

2. A voltage regulator comprising: at least a control circuit and a plurality of parallel-connected output transistors that is controlled by the control circuit;
switch means provided in series with a corresponding one(s) of the output transistors,
wherein the switch means is controlled based on a value of an output current to control a W/L value of the output transistors.

3. A voltage regulator comprising: at least a control circuit and a plurality of parallel-connected output transistors that is controlled by the control circuit;
an output current detection circuit connected in parallel with a power supply for detecting an output current; and
switch means provided in series with a corresponding one(s) of the output transistors,
wherein a W/L value of the output transistors is controlled by controlling the switch means based on an output signal from the output current detection circuit.

4. A voltage regulator according to claim 3, wherein the output current detection circuit includes a transistor that is controlled by the control circuit, and a resistor.
